(19) United States
(12) Patent Application Publication
(10) Pub. No.: US 2018/0158058 A1
(43) Pub. Date: Jun. 7, 2018

(54) APPARATUS AND METHOD TO PREVENT EXECUTION OF AN UNAUTHORIZED TRANSACTION VIA A DISTRIBUTED DATABASE

(71) Applicant: FUJITSU LIMITED, Kawasaki-shi (JP)

(72) Inventor: Jun KOGURE, Kawasaki (JP)

(73) Assignee: FUJITSU LIMITED, Kawasaki-shi (JP)

(21) Appl. No.: 15/828,949

(22) Filed: Dec. 1, 2017

(30) Foreign Application Priority Data
Dec. 6, 2016 (JP) 2016-237096

(51) Int. Cl. G06Q 20/40; H04L 29/06; H04L 9/30; H04L 29/08

(52) U.S. Cl. CPC G06Q 20/401; H04L 63/08; H04L 2209/56; H04L 67/104; H04L 67/1097; H04L 9/30

(57) ABSTRACT

An apparatus determines whether public key information on a public key used by a transaction made between nodes coupled to each other via a network is stored in a distributed database, and determines whether challenge response authentication using the public key is successful between the nodes between which the transaction is made. When the public key information is stored in the distributed database and the challenge response authentication is successful, the apparatus stores information on the transaction using the public key in the distributed database.

### CROSS-REFERENCE TO RELATED APPLICATION

This application is based upon and claims the benefit of priority of the prior Japanese Patent Application No. 2016-237096, filed on Dec. 6, 2016, the entire contents of which are incorporated herein by reference.

### FIELD

The embodiment discussed herein is related to apparatus and method to prevent execution of an unauthorized transaction via a distributed network.

### BACKGROUND

For instance, in a case where crypto currency such as Bitcoin (registered trademark) is traded, a transaction using a public key on P2P network is conducted. For instance, when payment is made from a payment device to a receiving device, a management device of the transaction verifies a payment transaction which is signed with a secret key of the payment device, using a public key paired with the secret key. Thus, unauthorized payment transaction is excluded, and payment from the payment device to the receiving device is made in an authorized manner.

Related techniques are disclosed in, for example, Japanese Laid-open Patent Publication No. 2016-81134.

### SUMMARY

According to an aspect of the invention, an apparatus determines whether public key information on a public key used by a transaction made between nodes coupled to each other via a network is stored in a distributed database, and determines whether challenge response authentication using the public key is successful between the nodes between which the transaction is made. When the public key information is stored in the distributed database and the challenge response authentication is successful, the apparatus stores information on the transaction using the public key in the distributed database.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a transaction system, according to an embodiment;

FIG. 2 is a diagram illustrating an example of a payment transaction of a crypto currency using a P2P network, according to an embodiment;

FIG. 3 is a diagram illustrating an example of a payment transaction, according to an embodiment;

FIG. 4 is a diagram illustrating an example of a block chain, according to an embodiment;

FIG. 5 is a diagram illustrating an example of a payment transaction when a key pair is duplicated;

FIG. 6 is a diagram illustrating an example of a payment transaction using challenge response authentication, according to an embodiment;

FIG. 7 is a diagram illustrating an example of a functional configuration of a payment device, according to an embodiment;

FIG. 8 is a diagram illustrating an example of a payment transaction including public key information, according to an embodiment;

FIG. 9 is a diagram illustrating an example of a functional configuration of a receiving device, according to an embodiment;

FIG. 10 is a diagram illustrating an example of a payment transaction including authentication information, according to an embodiment;

FIG. 11 is a diagram illustrating an example of a functional configuration of a management device, according to an embodiment;

FIG. 12 is a diagram illustrating an example of an operational sequence for making a payment transaction, according to an embodiment;

FIG. 13 is a diagram illustrating an example of an operational flowchart for public key registration request processing, according to an embodiment;

FIG. 14 is a diagram illustrating an example of an operational flowchart for public key registration processing, according to an embodiment;

FIG. 15 is a diagram illustrating an example of an operational flowchart for authentication processing, according to an embodiment;

FIG. 16 is a diagram illustrating an example of an operational flowchart for authentication registration processing, according to an embodiment;

FIG. 17 is a diagram illustrating an example of an operational flowchart for payment processing, according to an embodiment;

FIG. 18 is a diagram illustrating an example of an operational flowchart for payment approval processing, according to an embodiment; and

FIG. 19 is a diagram illustrating an example of a hardware configuration of a computer that executes a transaction management program, according to an embodiment.

### DESCRIPTION OF EMBODIMENT

With the above-mentioned technique, payment may be made from a crypto currency owner other than the payment device to the receiving device.

For example, when the pair (key pair) of a secret key and a public key of the payment device matches the key pair of a third party, payment may be made from the third party to the receiving device even though payment is made by the payment device. A key pair is generated, for instance, based on random numbers generated automatically by a computer. Therefore, the key pair of the payment device may coincide with key pair of a third party. Possibly, the payment device may illegally obtain and utilize the secret key of a third party, for instance, and payment which is not intended by the third party may be made. Like this, when key pairs match by any chance, unauthorized transaction may be conducted.

It is desirable to prohibit an unauthorized transaction.

Hereinafter, a transaction management method, a transaction management program and a transaction management device according to the present application with reference to the accompanying drawings. It is to be noted that this embodiment does not limit the technique of the disclosure.

### EMBODIMENT

[System Configuration]

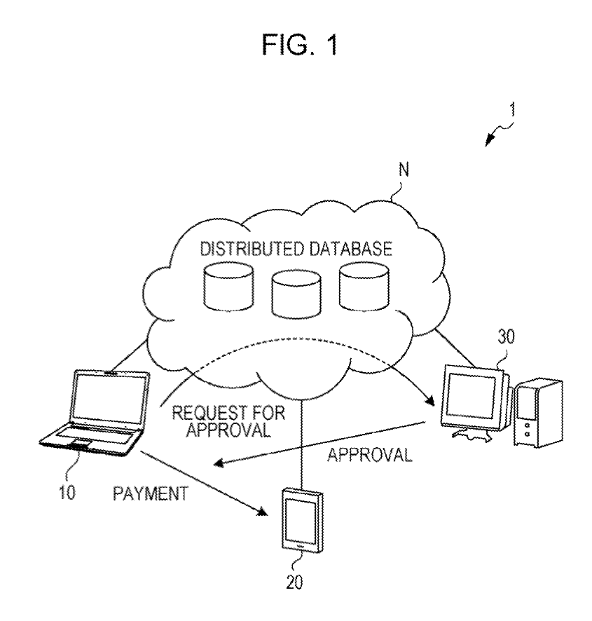

FIG. 1 is a diagram for illustrating a transaction system according to an embodiment. A transaction system 1 illustrated in FIG. 1 provides a currency transaction service by making transactions of crypto currency between nodes 10, 20, and 30 coupled via a peer to peer (P2P) network N not through a central organization such as a government or a central bank. The node 30 may include multiple nodes, and in this case, the node 30 uniquely updates a distributed database (DB) by an agreement mechanism such as Proof of Work (PoW).

As illustrated in FIG. 1, the transaction system 1 includes the nodes 10, 20, and 30 coupled via P2P network N. In the transaction system 1, transactions of crypto currency are conducted between the nodes. Here, it is assumed that payment of crypto currency is made from the node 10 to the node 20. Specifically, it is assumed that the node 10 is a payment device, the node 20 is a receiving device, and the node 30 is a management device that manages transaction Tx.

In this case, for instance, a request to the receiving device (node) 20 for approval of payment is transmitted from the payment device (node) 10 to the management device (node) 30 via P2P network N. After receiving an approval request, the management device 30 verifies and approves the payment. The management device 30 stores information on the payment in the distributed database (DB) on the P2P network N by broadcasting approval of payment to the P2P network N. It is to be noted that for instance, when multiple management devices 30 are present, the management devices 30 uniquely stores information on payment by an agreement mechanism such as Proof of Work (PoW). In this manner, payment from the payment device 10 to the receiving device 20 is completed.

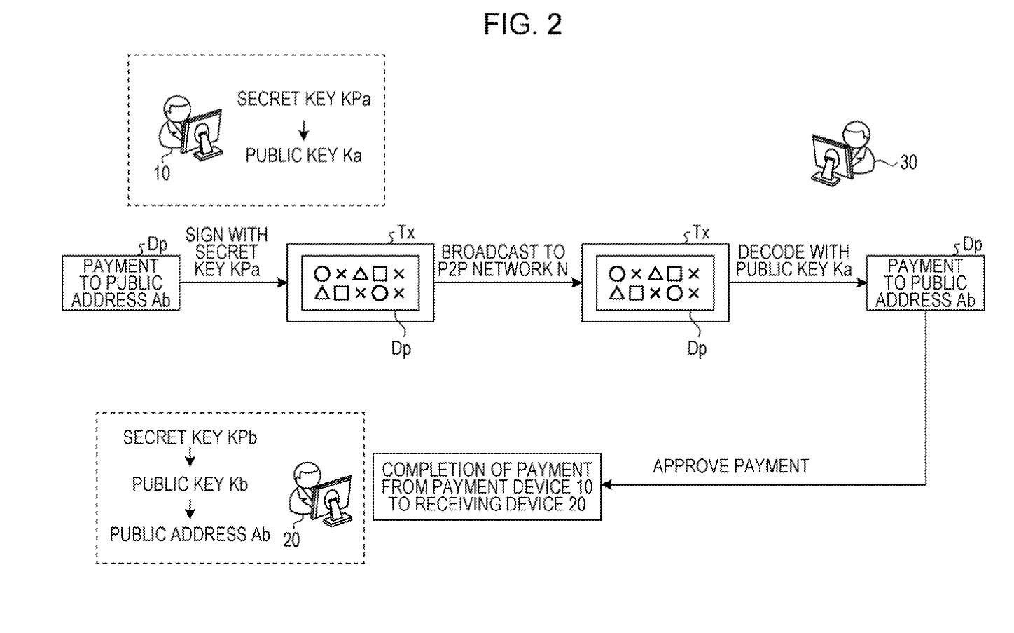

The crypto currency used in such a payment transaction Tx is a virtual currency in which transaction is made utilizing an electronic signature using a key pair of a public key and a secret key. For instance, Bitcoin is known as a transaction system that makes payment transaction Tx of crypto currency using P2P network N. In this embodiment, an example will be described in which the transaction system 1 is Bitcoin. First, typical payment transaction Tx in Bitcoin is described with reference to FIGS. 2 to 4.

It is to be noted that various transaction systems such as Monacoin and Litecoin other than Bitcoin are known as a transaction system that makes payment transaction Tx of crypto currency using P2P network N. Also, the object of transaction in the transaction system 1 is not limited to the crypto currency. The object of transaction in the transaction system 1 includes, for instance, financial products such as stocks, bonds, in other words, products that may be transacted over P2P network N and have predetermined values. It is to be noted that in this case, instead of the payment transaction Tx, a transaction such as buying and selling of a product is made.

FIG. 2 is a diagram for illustrating the payment transaction Tx of a crypto currency using a P2P network N. As illustrated in FIG. 2, the payment device 10 generates a secret key Kpa by using a random number sequence. The payment device 10 generates a public key Ka from the secret key Kpa. Similarly, the receiving device 20 also generates a secret key KPb and a public key Kb. The receiving device 20 generates a public address Ab by applying a hash function to and encoding the public key Kb, and notifies the payment device 10 of the public address Ab. It is to be noted that a notification method for the public address Ab includes, for instance, notification by E-mail, and notification by disclosing the public address Ab on the Web. It is sufficient to enable the payment device 10 to obtain the public address Ab of the receiving device 20, and any notification method may be used.

Upon obtaining the public address Ab from the receiving device 20, the payment device 10 generates payment data Dp including payment information indicating that payment is to be made to the public address Ab. The payment device 10 signs the payment data Dp with the secret key Kpa, and makes a request to the management device 30 for approval of payment by broadcasting payment transaction Tx including the payment data Dp after the signature to the P2P network N.

Upon obtaining the payment transaction Tx via the P2P network N, the management device 30 uses the public key Ka of the payment device 10 to verify whether or not the payment data Dp is signed with the secret key Kpa corresponding to Ka.

When the payment transaction Tx is valid, the management device 30 stores the payment transaction Tx in the distributed database, thereby approving the payment. Thus, payment from the payment device 10 to the receiving device 20 is completed.

In general, software called a wallet is used for the payment described above. Foe example, the nodes 10, 20 implement the function of one of a payment device and a receiving device by downloading the wallet into a computer and connecting with the P2P network N. Also, software and hardware, in which an agreement mechanism such as mining is implemented, is used for management of DB performed by the node 30. It is to be noted that the wallet is software that manages crypto currency by generating a key pair, generating a public address, and transmitting the payment transaction Tx. It is to be noted that computers to which the wallet is downloaded includes a personal computer, a smartphone, and a tablet terminal. Computers, which perform transaction management such as mining, include a server and dedicated hardware such as LSI.

Here, although it is assumed that the node 10 is a payment device, the node 20 is a receiving device, and the node 30 is a management device, the embodiment is not limited to this. For example, the node 20 may be a payment device, and the node 30 may be a receiving device when payment is made from the node 20 to the node 30. In addition, the number of nodes included in the transaction system 1 is not limited to three. The number of nodes may be three or greater.

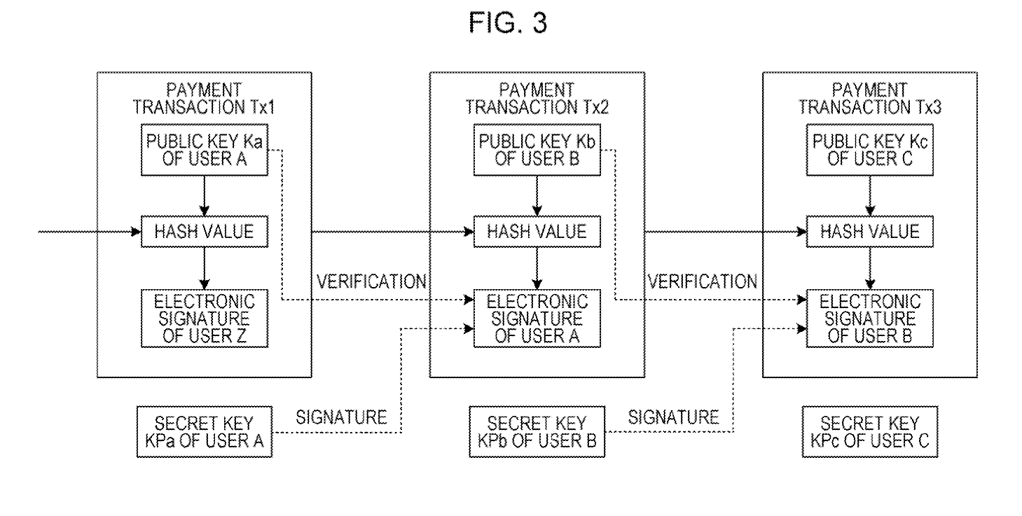

Next, the details of the payment transaction Tx of crypto currency will be described with reference to FIG. 3. FIG. 3 is a diagram for illustrating the payment transaction Tx.

Crypto currency is represented as a chain of transactions. When a user (the payment device 10 in FIG. 2) pays crypto currency to another user (the receiving device 20 in FIG. 2), the user electronically signs the content of the transaction Tx by using the secret key KPa of the payment device 10, and guarantees that the content is what the payment device 10 intends to do.

For example, as illustrated in FIG. 3, it is assumed that payment is made from a user Z to a user A, then payment is made from the user A to a user B, and payment is made from the user B to a user C.

A case will be described in which payment is made from the user A who represents the payment device 10 to the user B who represents the receiving device 20 in FIG. 3. In this case, the user A broadcasts a payment transaction Tx2 to the P2P network N, where the payment transaction Tx2 is obtained by signing, with the secret key KPa, both a hash value of the payment transaction Tx1 from the user Z to the user A, and a hash value obtained by applying a hash function to the public key Kb of the user B. Thus, the payment transaction Tx2 is added subsequent to the payment transaction Tx1. It is to be noted the hash value obtained by applying a hash function to the public key Kb of the user B corresponds to the public address Ab of the user B.

The nodes, such as the user B and the management device 30 (see FIG. 2) included in the transaction system 1, verify the payment transaction Tx2 with the public key Ka of the user A, and compares the payment transaction Tx2 with the hash value of the payment transaction Tx1 and the public address Ab of the user B. Thus, the nodes included in the transaction system 1 may determine presence or absence of change of the payment transaction Tx2, and may verify the validity of the payment transaction Tx2.

A case in which payment is made from the user B to the user C is similarly described. For example, the user B who represents the payment device 10 broadcasts a payment transaction Tx3 to the P2P network N, where the payment transaction Tx3 is obtained by signing, with the secret key KPb, both a hash value of the payment transaction Tx2, and a hash value of the public key Kc of the user C who represents the receiving device 20. Thus, the payment transaction Tx3 is added subsequent to the payment transaction Tx2, and the validity of the payment transaction Tx3 is verified, for instance, by the management device 30 (see FIG. 2).

In this manner, when payment is made from the payment device 10 to the receiving device 20, the validity of the current payment transaction Tx is verified with the public key included in the last payment transaction Tx. Therefore, users who may represent the payment device 10 are limited to those users who have a secret key paired with the public key included in the last payment transaction Tx. Therefore, the secret key is required to be managed so that the secret key is different from secret keys of other users or the secret key is not leaked to a third party.

However, as described above, a secret key is generated using a random number. In general, a random number is determined by specific calculation using a function such as a pseudo-random number generation function that uses a certain numerical value as a seed value. Therefore, when the same seed value is used, the same random numbers may be generated.

When the random numbers are the same, secret keys generated using the random numbers are also the same. Like this, when the same seed value is used, the secret key of the payment device 10 may be coincident with a secret key of a third party. In this case, public keys generated using the same secret key are coincident with each other. Thus, the payment device 10 may pay the crypto currency of a third party to the receiving device 20 contrary to the intention of the payment device 10. Also when the payment device 10 illegally obtains the secret key of a third party, it is possible for the payment device 10 to pay the crypto currency of the third party to the receiving device 20.

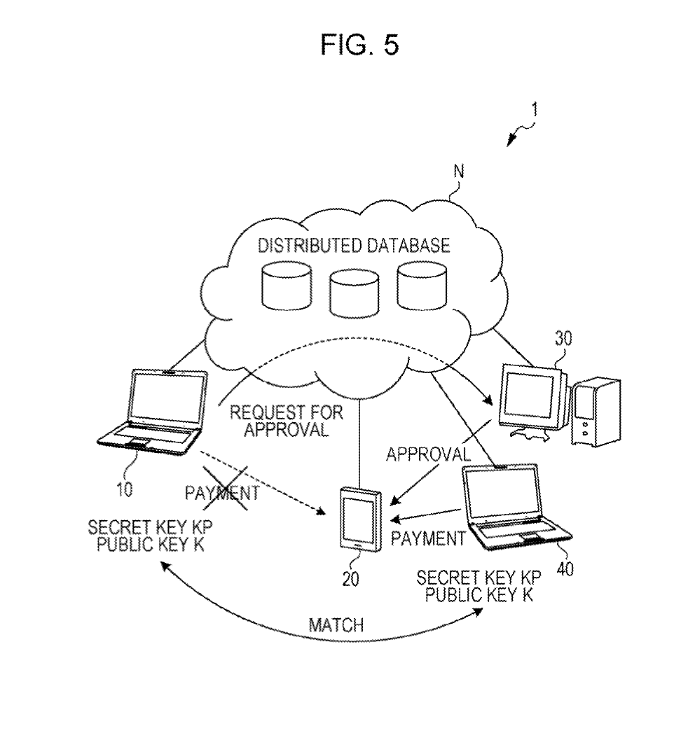

Like this, the verification of the validity of the payment transaction Tx, conducted by the management device 30, may fail to prevent unauthorized payment transaction Tx from being made. Thus, the transaction system 1 according to this embodiment performs challenge response authentication using a key pair between the payment device 10 and the receiving device 20, and verifies the payment transaction Tx along with a result of the authentication, thereby prohibiting the conduct of unauthorized payment transaction Tx. This point will be described later with reference to FIG. 5, and here, the typical payment transaction Tx is continuously described.

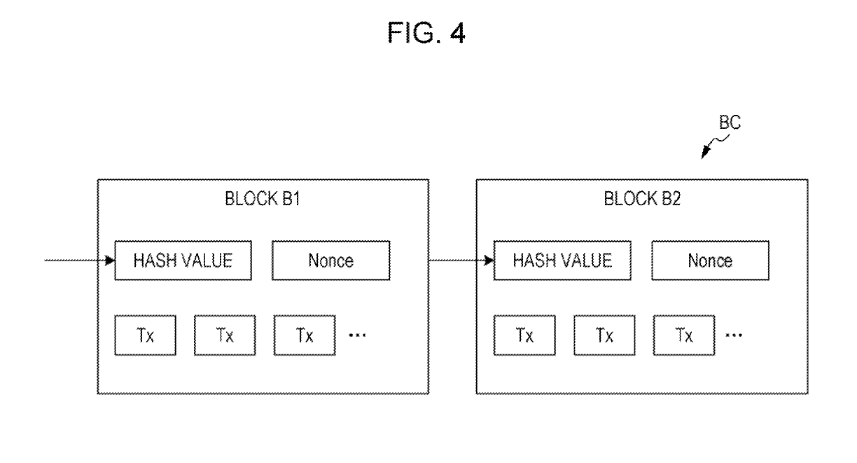

Next, the approval of the payment transaction Tx made by the management device 30 will be described with reference to FIG. 4. FIG. 4 is a diagram for illustrating a block chain BC. The management device 30 adds a block B2 including the payment transaction Tx to the end of the block chain BC, thereby approving the payment transaction Tx. In other words, the block chain BC serves as a distributed database, and the management device 30 adds the new block B2 to the block chain BC, thereby storing the approved payment transaction Tx in the distributed database.

As illustrated in FIG. 4, the blocks B1, B2 each store a hash value, a Nonce, and multiple payment transactions Tx. The hash value is a value generated using the previous block B1 and the Nonce included in the block B1, and satisfies a predetermined condition. The management device 30 is able to add the block B2 to the block chain BC by finding a Nonce which allows a hash value satisfying a predetermined condition to be generated. In this manner, a consistent history of the transaction Tx is recorded in the block chain BC.

A node that performs calculation of finding a Nonce is called a miner. The miner, which has found a Nonce, adds the block B2 to the block chain BC as the management device 30 in this embodiment, thereby approving the payment transaction Tx.

In order to find such a Nonce, a hash operation has to be performed in a full search and round-robin manner, and the amount of calculation (work load) is significantly increased. In the transaction system 1, a consistent history of the transaction Tx is recorded in the block chain BC according to the size of work load, and thus protection is provided against counterfeit crypto currency (proof of work).

Next, the payment transaction Tx when a key pair is duplicated will be described with reference to FIG. 5. FIG. 5 is a diagram for illustrating the payment transaction Tx when a key pair is duplicated. As described above, for instance, when the same seed value of a random number generation function is used, key pairs of the secret key KP and the public key K of multiple nodes 10, 40 may be coincident with each other.

In this case, for instance, even when the node 10 as a payment device makes a request to the management device 30 for approval of payment to the receiving device 20, the management device 30 may approve payment from the node 40 to the receiving device 20. Thus, payment is not made from the payment device 10 to the receiving device 20, but payment is made from the node 40 to the receiving device 20.

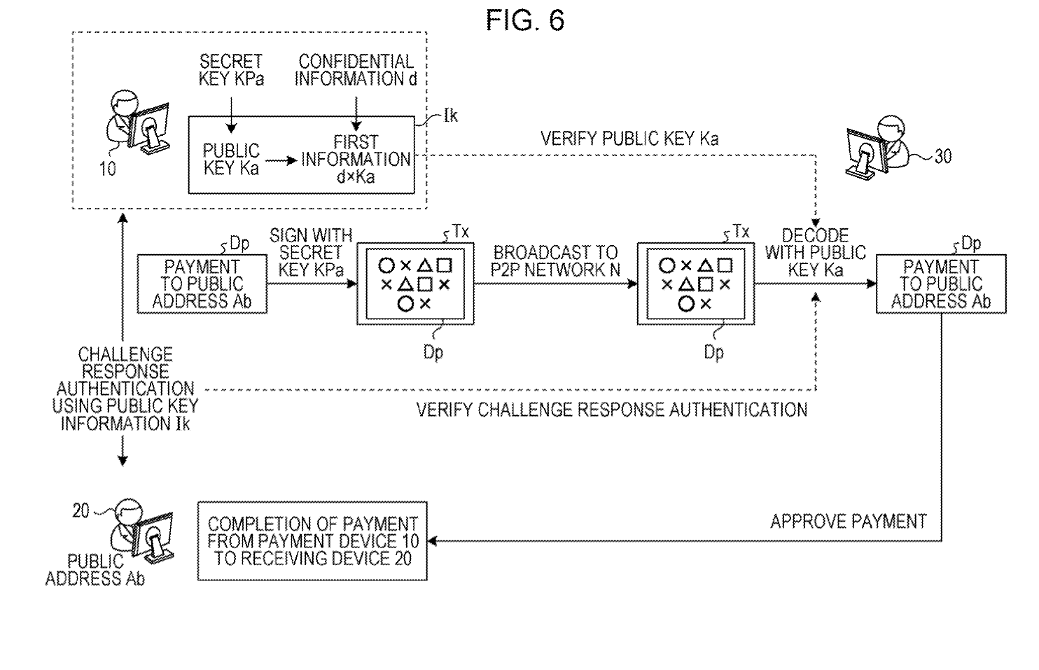

Like this, when the key pairs of multiple nodes 10, 40 are duplicated, unauthorized payment transaction Tx is conducted. Thus, the transaction system 1 according to this embodiment performs the challenge response authentication using a key pair between the payment device 10 and the receiving device 20, and verifies the payment transaction Tx along with a result of the authentication, thereby prohibiting the conduct of unauthorized payment transaction Tx. This point will be described with reference to FIG. 6.

FIG. 6 is a diagram for illustrating the payment transaction Tx using the challenge response authentication according to the embodiment.

The management device 30 determines whether or not public key information on the public key Ka used for the payment transaction Tx made between the payment device 10 and the receiving device 20 is stored in the distributed database. The management device 30 determines whether or not the challenge response authentication using the public key Ka is successful between the payment device 10 and the receiving device 20 that have made the payment transaction Tx. When the public key information is stored in the distributed database and the challenge response authentication is successful, the management device 30 stores information on the payment transaction Tx using the public key Ka in the distributed database.

As illustrated in FIG. 6, the payment device 10 generates a public key Ka by using the secret key KPa. The payment device 10 generates confidential information d, and generates first information dxKa based on the confidential information d and the public key Ka. The payment device 10 broadcasts the public key Ka and the first information dxKa as public key information Ik to the P2P network N. The public key information Ik is stored in the distributed database by the management device 30.

It is to be noted herein, a case has been described in which the first information is generated by multiplying the confidential information d by the public key Ka, that is, dxKa. However, a method of generating the first information is not limited to this. It is sufficient that the first information be generated based on the confidential information d and the public key Ka, and the first information may be generated by multiplying the public key Ka by the confidential information d, that is, Kaxd. Alternatively, the first information may be generated by calculating dth power of the public key Ka, that is, KaAd, or the first information may be generated by calculating Ka-th power of the confidential information d, that is, d̂Ka. In the following description, y-th power of x will be abbreviated as x̂y.

Next, when payment is made from the payment device 10 to the receiving device 20, the payment device 10 and the receiving device 20 first perform the challenge response authentication using the public key information Ik. When the challenge response authentication is successful, the receiving device 20 broadcasts a result of the authentication, for instance.

Subsequently, the payment device 10 obtains a public address Ab from the receiving device 20, and makes a request to the management device 30 for approval of payment by broadcasting the payment transaction Tx to the P2P network N. It is to be noted that the payment transaction Tx is the same as the payment transaction Tx illustrated in FIG. 2, thus the description thereof is omitted.

After receiving an approval request from the payment device 10, the management device 30 verifies the public key Ka by determining whether or not the public key information Ik is stored in the distributed database. When the public key information Ik is stored in the distributed database, the management device 30 determines that the public key Ka included in the public key information Ik is valid.

Next, the management device 30 verifies the challenge response authentication performed between the payment device 10 and the receiving device 20. For instance, when an authentication result indicating that the challenge response authentication is successful has been broadcasted by the receiving device 20, the management device 30 determines that the challenge response authentication is valid.

When it is determined that the public key Ka is valid and the challenge response authentication is valid, the management device 30 verifies whether or not the payment data Dp after the signature is valid, using the public key Ka.

When the payment transaction Tx is valid, the management device 30 stores the payment transaction Tx in the distributed database, and thereby approves the payment. Thus, payment from the payment device 10 to the receiving device 20 is completed.

In this manner, when the key pair of the payment device 10 is valid, and the challenge response authentication performed between the payment device 10 and the receiving devices 20 is successful, the management device 30 approves the payment transaction Tx. This allows duplication of a key pair to be avoided, and the conduct of unauthorized payment transaction Tx may be prohibited.

[Configuration of Payment Device 10]

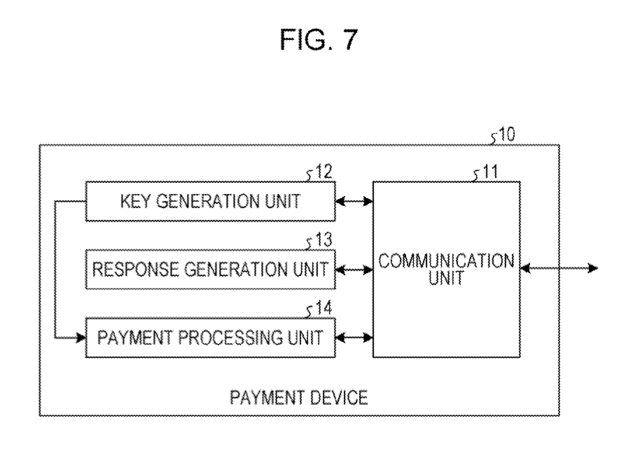

Next, the configuration of the payment device 10 included in the transaction system 1 according to the embodiment will be described with reference to FIG. 7. FIG. 7 is a block diagram illustrating the functional configuration of the payment device 10 according to the embodiment.

Although the functional units corresponding to symbols 11 to 14 are illustrated in FIG. 7, this is only an example, and part of the illustrated functional units may be omitted, or a functional unit which is not illustrated may be included in the payment device 10. For instance, when a personal computer is implemented as the payment device 10, the personal computer may have the functional units included as standard in PC, for instance, functional units such as an input device, and an image or voice output device.

As illustrated in FIG. 7, only as an example, the payment device 10 includes a communication unit 11, a key generation unit 12, a response generation unit 13, and a payment processing unit 14.

The communication unit 11 is an interface that performs communication control between the payment device 10 and other devices via the P2P network N, for instance, the receiving device 20 and the management device 30.

In an embodiment, a network interface card such as a LAN card may be used for the communication unit 11. For instance, the communication unit 11 receives a challenge code related to the challenge response authentication from the receiving device 20, or transmits a request for approval of the payment transaction Tx to the management device 30.

The key generation unit 12 is a processing unit that generates the public key information Ik.

In an embodiment, the key generation unit 12 generates public key information Ik before payment is made to the receiving device 20. For instance, the key generation unit 12 generates a first random number and a second random number. Alternatively, the key generation unit 12 generates one random number, and may generate the first and second random numbers by dividing the one random number into two sequences. The key generation unit 12 generates a secret key KPa using the first random number. The key generation unit 12 generates a public key Ka, by using the secret key KPa, based on, for instance, the Elliptic Curve DigitalSignature Algorithm (ECDSA). Also, the key generation unit 12 generates first information dxKa by performing scalar multiplication between confidential information d and the public key Ka, where the confidential information d is the second random number. It is to be noted the scalar multiplication is multiplication on an elliptic curve. It is to be noted that although a case in which ECDSA is used as the public key cryptosystem is described, without being limited to this, for instance, RSA cryptography, which is an algorithm other than the cryptographic algorithm using an elliptic curve, may be used.

The key generation unit 12 makes a request to the management device 30 for registration of the public key information Ik by broadcasting the generated public key Ka and first information dxKa as the public key information Ik to the P2P network N via the communication unit 11.

In an embodiment, the key generation unit 12 makes a request for registration of the public key information Ik by using the payment transaction Tx. For instance, the key generation unit 12 makes a request for registration of the public key information Ik by broadcasting the payment transaction Tx including the public key information Ik.

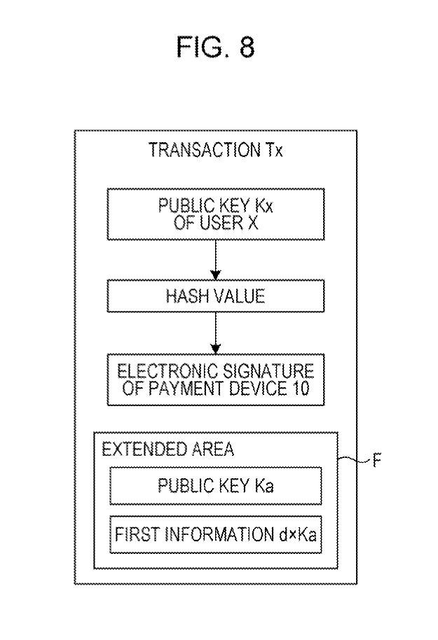

FIG. 8 is a diagram for illustrating the payment transaction Tx including the public key information Ik. As illustrated in FIG. 8, in addition to an area that stores information (payment information) on payment made by the payment device 10, such as an electronic signature of the payment device 10, the payment transaction Tx includes an extended area F in which other information may be stored. Thus, the key generation unit 12 generates a payment transaction Tx which stores the public key information Ik including the generated public key Ka and first information dxKa in the extended area F. Thus, the key generation unit 12 may make a request to the management device 30 for registration of the public key information Ik using the payment transaction Tx.

It is to be noted such a request for registration is made by the payment device 10, and a payee is not present. Thus, the key generation unit 12 of the payment device 10 generates a payment transaction Tx with a payee at a public address Ax generated by using a fictitious public key Kx of an unreal user X, for instance. Alternatively, payment may be made to the payment device 10 itself. Specifically, it is possible to generate a payment transaction Tx with a payee at the public address Aa of the payment device 10 itself. Alternatively, the transaction system 1 may prepare a public address AO for making a request for registration of the public key information Ik, and the key generation unit 12 may generate a payment transaction Tx whose payee is the public address AO. It is to be noted that hereinafter the payment transaction Tx including the public key information Ik is also referred to as a public key transaction Txk.

In this manner, the key generation unit 12 may generate public key information Ik including the public key Ka in addition to a key pair of the secret key KPa and the public key Ka. In addition, the key generation unit 12 may make a request to the management device 30 for registration of the public key information Ik.

The response generation unit 13 is a processing unit that generates a response code RC in the challenge response authentication.

In an embodiment, when obtaining a challenge code CC from the receiving device 20 via the communication unit 11, the response generation unit 13 performs scalar multiplication between the challenge code CC and the confidential information d, and generates the response code d̂CC where d̂CC is CC-th power of d. The response generation unit 13 transmits the generated response code d̂CC to the receiving device 20.

The payment processing unit 14 is a processing unit that generates a payment transaction Tx.

In an embodiment, upon receiving a notification of successful challenge response authentication via the communication unit 11, the payment processing unit 14 obtains a public address Ab from the receiving device 20. The payment processing unit 14 affixes an electronic signature using the secret key KPa, and generates the current payment transaction Tx (see FIG. 3). The payment processing unit 14 makes a request to the management device 30 for registration of the payment transaction Tx by broadcasting the generated payment transaction Tx to the P2P network N via the communication unit 11.

[Configuration of Receiving Device 20]

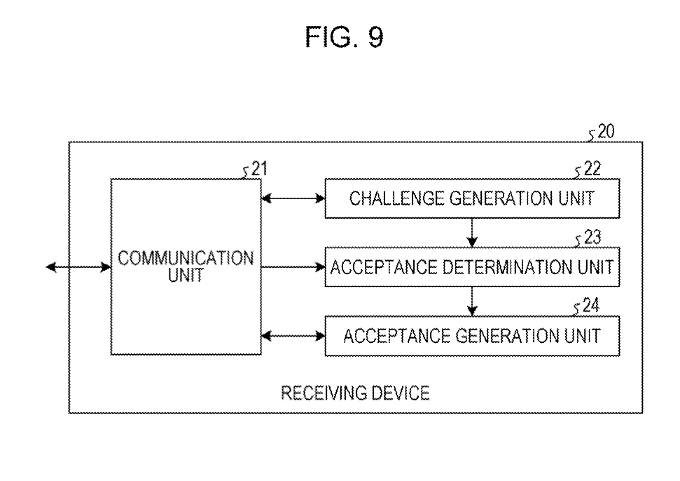

Next, the configuration of the receiving device 20 included in the transaction system 1 according to this embodiment will be described with reference to FIG. 9. FIG. 9 is a block diagram illustrating the functional configuration of the receiving device 20 according to the embodiment.

Although the functional units corresponding to symbols 21 to 24 are illustrated in FIG. 9, this is only an example, and part of the illustrated functional units may be omitted, or a functional unit which is not illustrated may be included in the receiving device 20. For instance, when a personal computer is implemented as the receiving device 20, the personal computer may have the functional units included as standard in PC, for instance, functional units such as an input device, and an image or voice output device.

As illustrated in FIG. 9, only as an example, the receiving device 20 includes a communication unit 21, a challenge generation unit 22, an acceptance determination unit 23, and an acceptance generation unit 24.

The communication unit 21 is an interface that performs communication control between the receiving device 20 and other devices via the P2P network N, for instance, the payment device 10 and the management device 30.

In an embodiment, a network interface card such as a LAN card may be used for the communication unit 21. For instance, the communication unit 21 receives a response code RC related to the challenge response authentication from the payment device 10, or transmits a request for registration of authentication information on the challenge response authentication to the management device 30.

The challenge generation unit 22 is a processing unit that generates a challenge code CC in the challenge response authentication.

In an embodiment, before receiving payment from the payment device 10, the challenge generation unit 22 generates a challenge code CC, and transmits the challenge code CC to the payment device 10 via the communication unit 21. The challenge generation unit 22 obtains public key information Ik on the payment device 10, for instance via the communication unit 21. The challenge generation unit 22 generates confidential information u at random, for instance, by using a random number generation function. It is to be noted confidential information u is newly generated each time challenge response authentication is performed. The challenge generation unit 22 generates a challenge code CC=ûKa by performing scalar multiplication between the generated confidential information u and the public key Ka included in the public key information Ik. The challenge generation unit 22 transmits the generated challenge code CC to the payment device 10 via the communication unit 21.

The acceptance determination unit 23 is a processing unit that determines whether or not the challenge response authentication is successful (accepted), based on the response code RC obtained from the payment device 10.

In an embodiment, the acceptance determination unit 23 obtains the response code RC from payment device 10 via the communication unit 21. As described above, the response code RC is RC=d̂CC which is obtained by performing scalar multiplication between the challenge code CC and confidential information d. Here, since the challenge code CC is CC=ûKa, the response code RC is RC=d̂(ûKa) In addition, the acceptance determination unit 23 generates a verification code VC=û (d×Ka) by performing scalar multiplication between the first information dxKa included in the public key information Ik obtained from the payment device 10 and the confidential information u. When the generated verification code VC=û(d×Ka) matches the response code RC=d̂(ûKa), the acceptance determination unit 23 determines that the challenge response authentication is successful.

The acceptance generation unit 24 is a processing unit that, when the acceptance determination unit 23 determines that challenge response authentication is successful, generates an acceptance code AC.

In an embodiment, upon obtaining a result of determination indicating successful challenge response authentication from the acceptance determination unit 23, the acceptance generation unit 24 generates an acceptance code AC. The acceptance generation unit 24 generates authentication information Ia which is on the challenge response authentication and includes the acceptance code AC. For instance, the acceptance generation unit 24 generates authentication information Ia including a challenge code CC, a response code RC, and an acceptance code AC.

In an embodiment, the acceptance generation unit 24 notifies the payment device 10 of successful authentication as well as makes a request to the management device 30 for registration of the authentication information Ia by broadcasting the payment transaction Tx including the authentication information Ia via the communication unit 21.

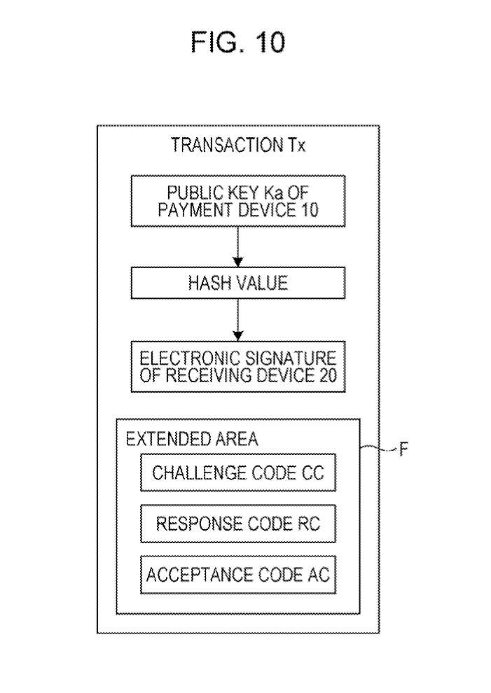

FIG. 10 is a diagram for illustrating the payment transaction Tx including the authentication information Ia. As described above, in addition to the area that stores information on payment, the payment transaction Tx includes the extended area F. The acceptance generation unit 24 generates a payment transaction Tx which stores the authentication information Ia including a challenge code CC, a response code RC, and an acceptance code AC in the extended area F, and broadcasts the payment transaction Tx to the P2P network N. Consequently, the acceptance generation unit 24 may notify the payment device 10 of the authentication information Ia using the payment transaction Tx, and may make a request to the management device 30 for registration of the authentication information Ia.

In an embodiment, the acceptance generation unit 24 generates a payment transaction Tx which includes the authentication information Ia and whose payee is the payment device 10. Thus, the acceptance generation unit 24 may notify the management device 30 that the payment device 10 has been authenticated. It is to be noted a payee for the payment transaction Tx including the authentication information Ia is not limited to the payment device 10. For instance, payment may be made to the receiving device 20 itself. Specifically, it is possible to generate a payment transaction Tx with a payee at the public address Ab of the receiving device 20 itself. Alternatively, the transaction system 1 may prepare a public address AO for making a request for registration of the authentication information Ia, and the acceptance generation unit 24 may generate a payment transaction Tx whose payee is the public address AO. It is to be noted hereinafter, the payment transaction Tx including the authentication information Ia is also referred to as an authentication transaction Txa.

[Configuration of Management Device 30]

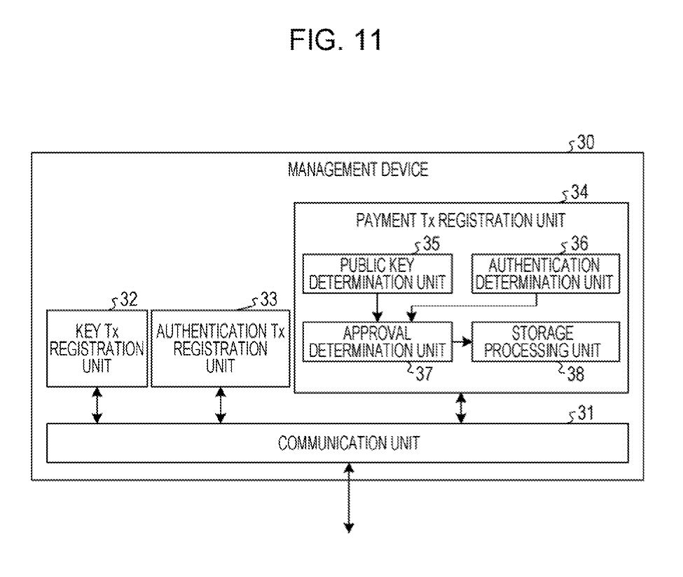

The configuration of the management device 30 included in the transaction system 1 according to this embodiment will be described with reference to FIG. 11. FIG. 11 is a block diagram illustrating the functional configuration of the management device 30 according to the embodiment.

Although the functional units corresponding to symbols 31 to 34 are illustrated in FIG. 11, this is only an example, and part of the illustrated functional units may be omitted, or a functional unit which is not illustrated may be included in the management device 30. For instance, when a personal computer is implemented as the management device 30, the personal computer may have the functional units included as standard in PC, for instance, functional units such as an input device, and an image or voice output device.

As illustrated in FIG. 11, only as an example, the management device 30 includes a communication unit 31, a key Tx registration unit 32, an authentication Tx registration unit 33, and a payment Tx registration unit 34.

The communication unit 31 is an interface that performs communication control between the management device 30 and other devices via the P2P network N, such as the payment device 10 and the receiving device 20.

In an embodiment, a network interface card such as a LAN card may be used for the communication unit 31. For instance, the communication unit 31 receives a payment transaction Tx from the payment device 10, or transmits a result of approval of the payment transaction Tx to the payment device 10 and the receiving device 20.

The key Tx registration unit 32 is a processing unit that, upon receiving a public key transaction Txk, registers the public key information Ik.

In an embodiment, upon receiving a public key transaction Txk, the key Tx registration unit 32 determines whether or not the public key Ka included in the public key information Ik is already stored in the distributed database (block chain BC). When the public key Ka is not stored in the distributed database, the key Tx registration unit 32 registers the public key information Ik in the distributed database by storing the public key transaction Txk in the distributed database. For example, the key Tx registration unit 32 newly generates a block including the public key transaction Txk, and adds the block to the end of the block chain BC, thereby storing the public key transaction Txk in the distributed database (see FIG. 4). The key Tx registration unit 32 notifies the payment device 10 of a registration result of the public key information Ik via the communication unit 31.

The authentication Tx registration unit 33 is a processing unit that, upon receiving an authentication transaction Txa, registers the authentication information Ia.

In an embodiment, the authentication Tx registration unit 33 determines whether or not the authentication information Ia, included in the received authentication transaction Txa, includes a challenge code CC, a response code RC, and an acceptance code AC. In addition, the authentication Tx registration unit 33 determines whether or not the authentication information Ia is already stored in the distributed database. When the authentication information Ia includes a challenge code CC, a response code RC, and an acceptance code AC, and the authentication information Ia is not stored in the distributed database, the authentication Tx registration unit 33 stores the authentication information Ia in the distributed database. For example, the authentication Tx registration unit 33 newly generates a block including the authentication transaction Txa, and adds the block to the end of the block chain BC, thereby storing the authentication transaction Txa in the distributed database (see FIG. 4). The authentication Tx registration unit 33 notifies the receiving device 20 of a registration result of the authentication information Ia via the communication unit 31.

The payment Tx registration unit 34 is a processing unit that, upon receiving a payment transaction Tx including payment information from the payment device 10 to the receiving device 20, approves the payment and registers the payment transaction Tx. Only as an example, the payment Tx registration unit 34 includes a public key determination unit 35, an authentication determination unit 36, an approval determination unit 37, and a storage processing unit 38.

The public key determination unit 35 is a processing unit that determines whether or not a public key Ka for verifying the payment transaction Tx is registered in the distributed database.

In an embodiment, when the public key information Ik on the payment device 10 is stored in the distributed database via the communication unit 31, the public key determination unit 35 determines that a public key Ka for verifying the payment transaction Tx is registered. The public key determination unit 35 notifies the approval determination unit 37 of a result of the determination.

The authentication determination unit 36 is a processing unit that determines whether or not authentication information Ia on challenge response authentication using public key information Ik is registered in the distributed database.

In an embodiment, the authentication determination unit 36 determines whether or not authentication information Ia is stored in the distributed database via the communication unit 31. When authentication information Ia is stored, the authentication determination unit 36 obtains the authentication information Ia from the distributed database, and determines whether or not the authentication information Ia indicates successful challenge response authentication. When the authentication information Ia indicates successful challenge response authentication, the authentication determination unit 36 determines that the authentication information Ia is registered. The authentication determination unit 36 notifies the approval determination unit 37 of a result of the determination.

The approval determination unit 37 is a processing unit that verifies the payment transaction Tx according to a result of the determination of the public key determination unit 35 and the authentication determination unit 36, and determines whether or not the payment is authenticated.

In an embodiment, when the public key Ka and the authentication information Ia are registered in the distributed database, the approval determination unit 37 verifies the payment transaction Tx. When at least one of the public key Ka and the authentication information Ia is not registered in the distributed database, the approval determination unit 37 does not verify the payment transaction Tx, and rejects approval for the payment. It is to be noted verification of the payment transaction Tx is the same as the verification of a payment transaction Tx described above with reference to FIG. 2, for instance, and thus a description thereof is omitted.

In an embodiment, when a payment transaction Tx is approved based on a result of the verification of the payment transaction Tx, the approval determination unit 37 notifies the storage processing unit 38 of approval. Also, when a payment transaction Tx is not approved, the approval determination unit 37 notifies the payment device 10 and the receiving device 20 of disapproval, for instance, via the communication unit 31.

In other words, when all of the public key transaction Txk, the authentication transaction Txa, and the payment transaction Tx are satisfactory, the approval determination unit 37 authenticates the payment transaction Tx. Thus, the approval determination unit 37 may reject approval for, for instance, unauthorized payment transaction Tx such as a payment transaction Tx using a duplicated key pair, and may prohibit the conduct of unauthorized payment transaction Tx.

The storage processing unit 38 is a processing unit that, when the approval determination unit 37 approves a payment transaction Tx, stores the payment transaction Tx in the distributed database.

In an embodiment, the storage processing unit 38 stores a payment transaction Tx in the distributed database. Thus, the management device 30 completes the approval of the payment transaction Tx, and the payment from the payment device 10 to the receiving device 20 is completed. It is to be noted the method of storing a payment transaction Tx in the distributed database (block chain BC) by the storage processing unit 38 is the same as the method described above with reference to FIG. 4, for instance, and thus a description thereof is omitted.

In an embodiment, the storage processing unit 38 stores a payment transaction Tx including, for instance, public key information Ik and authentication information Ia in the distributed database. Specifically, the storage processing unit 38 stores the public key information Ik and the authentication information Ia in the extended area F of the payment transaction Tx. Thus, the storage processing unit 38 may store the payment transaction Tx, the public key transaction Txk, and the authentication transaction Txa as a single transaction Tx in the distributed database. Alternatively, one of the public key information Ik or the authentication information Ia may be included in the payment transaction Tx. Thus, for instance, a node such as the payment device 10 included in the transaction system 1 may refer to the public key information Ik and the authentication information Ia by referring to the payment transaction Tx. This allows the node to easily refer to the public key information Ik and the authentication information Ia, and the validity of the payment transaction Tx may be easily verified.

[Flow of Processing]

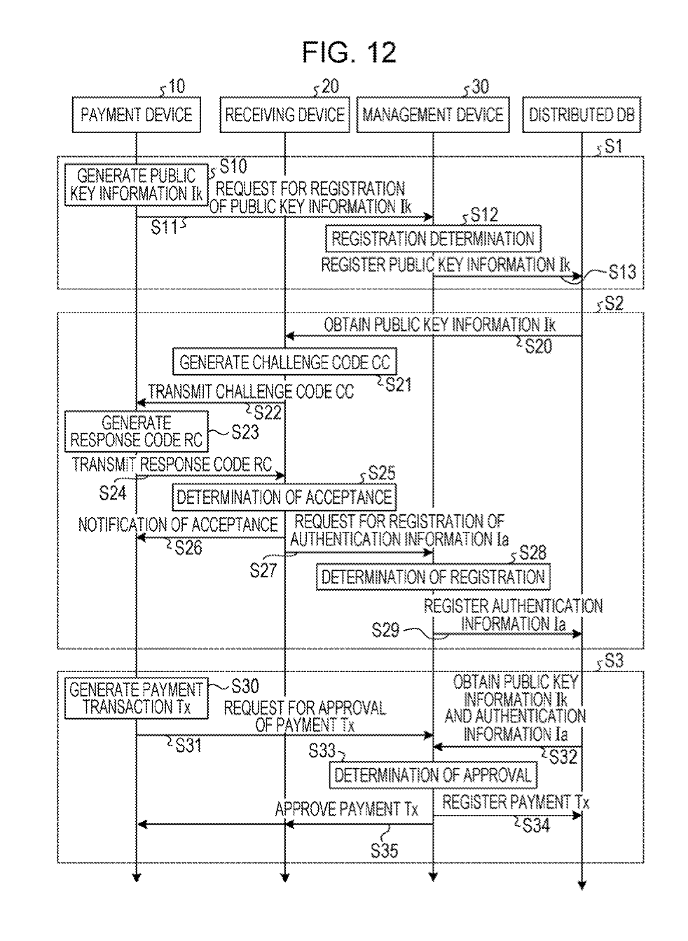

The processing performed by the transaction system 1 will be described with reference to FIGS. 12 to 18. The flow of processing performed by the transaction system 1 will be first described with reference to FIG. 12. FIG. 12 is a sequence diagram for making the payment transaction Tx according to the embodiment. The processing illustrated in FIG. 12 includes processing S1 for registering public key information Ik, processing S2 for performing challenge response authentication, and processing S3 for registering the payment transaction Tx.

When payment is made from the payment device 10 to the receiving device 20, the processing S1 for registering public key information Ik is first performed between the payment device 10 and the management device 30.

As illustrated in FIG. 12, the payment device 10 generates public key information Ik (step S10), and makes a request to the management device 30 for registration of the generated public key information Ik (step S11). Upon receiving the request for registration of the public key information Ik, the management device 30 determines whether or not the public key information Ik is to be registered (step S12). When it is determined that the public key information Ik is to be registered, the management device 30 registers the public key information Ik in the distributed database (distributed DB) (step S13).

Next, the payment device 10 and the receiving device 20 perform the processing S2 for performing challenge response authentication.

As illustrated in FIG. 12, the receiving device 20 obtains the public key information Ik of the payment device 10 from the distributed DB (step S20). The receiving device 20 generates a challenge code CC using the obtained public key information Ik (step S21), and transmits the challenge code CC to the payment device 10 (step S22).

The payment device 10, upon receiving the challenge code CC, generates a response code RC (step S23), and transmits the response code RC to the receiving device 20 (step S24).

The receiving device 20, upon receiving the response code RC, determines whether or not challenge response authentication is successful and authentication is accepted based on the response code RC (step S25). When the challenge response authentication is successful and the authentication is accepted, the receiving device 20 notifies the payment device 10 of acceptance (step S26), as well as makes a request to the management device 30 for registration of authentication information Ia (step S27) by broadcasting the authentication transaction Txa.

Upon receiving the request for registration of the authentication information Ia, the management device 30 determines whether or not the authentication information Ia is to be registered (step S28). When it is determined that the authentication information Ia is to be registered, the management device 30 registers the authentication information Ia in the distributed DB (step S29).

When the challenge response authentication is successfully performed between the payment device 10 and the receiving device 20, the processing S3 for registering the payment transaction Tx is performed between the payment device 10 and the management device 30.

The payment device 10 generates a payment transaction Tx (a payment Tx) that makes payment to the receiving device 20 (step S30), and makes a request to the management device 30 for approval of the payment Tx (step S31).

Upon receiving the request for approval of the payment Tx, the management device 30 obtains the public key information Ik, and the authentication information Ia from the distributed DB (step S32). The management device 30 determines whether or not the payment Tx is approved based on the obtained public key information Ik, authentication information Ia, and payment Tx (step S33). When the payment Tx is approved, the management device 30 stores the payment Tx in the distributed DB, thereby registering the payment Tx (step S34), and notifies the payment device 10 and the receiving device 20 of the approval of the payment Tx (step S35).

It is to be noted in FIG. 12, when payment is made from the payment device 10 to the receiving device 20, the public key information Ik is registered. However, without being limited to this, in a case where the payment device 10 registers the public key information Ik once, and subsequently makes payment using the public key information Ik multiple times, the public key information Ik does not have to be registered again. In short, the payment device 10 only has to register the public key information Ik when making payment using the public key information Ik for the first time. Therefore, the payment device 10 may register the public key information Ik at the timing of participating in the transaction system 1 by downloading the wallet.

In FIG. 12, when payment is made from the payment device 10 to the receiving device 20, challenge response authentication is performed. However, without being limited to this, in a case where the challenge response authentication using the public key information Ik is performed at least one time between the payment device 10 and the receiving devices 20, the challenge response authentication using the public key information Ik may be skipped. In other words, the challenge response authentication may be performed when the payment device 10 makes payment to the receiving device 20 by using the public key information Ik for the first time. Alternatively, when a predetermined time has not elapsed since the last challenge response authentication performed by the payment device 10 and the receiving device 20, the challenge response authentication may be skipped. Consequently, for instance, when the payment device 10 makes payment repeatedly to the receiving device 20, the challenge response authentication may be skipped, and thus the time taken for processing of the payment may be reduced.

In the processing S1 to S3 in FIG. 12, a case is presented in which registration to the distributed DB is performed by one management device 30. However, without being limited to this, different management devices 30 may perform registration to the distributed DB in the respective pieces of processing S1 to S3.

Also, in the above-described example, the payment device 10 and the receiving device 20 transmit the public key information Ik and the authentication information Ia by using the payment transaction Tx. However, without being limited to this, for instance, the payment device 10 and the receiving device 20 may generate and transmit a transaction Tx for transmitting the public key information Ik and the authentication information Ia. In this case, the transaction Tx does not have to include information on the payment such as information on a payee, thus the amount of information of the transaction Tx may be reduced.

Also, in the above-described example, the management device 30 stores the public key information Ik and the authentication information Ia in the same distributed database (block chain BC) as that of the payment transaction Tx. For instance, the distributed databases (block chain BC) that store the public key information Ik and the authentication information Ia may be prepared individually.

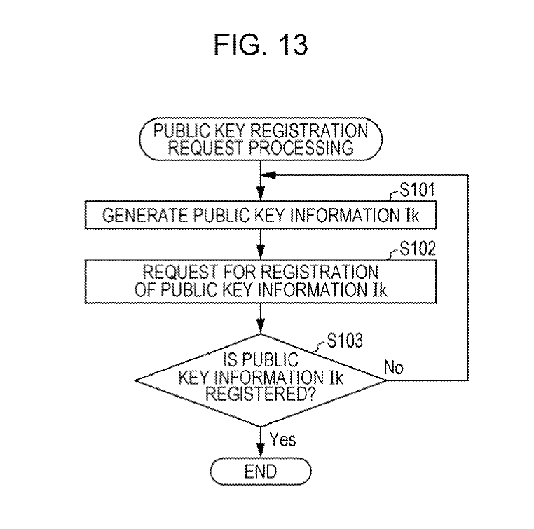

Next, the details of the processing performed by each device of the transaction system 1 will be described with reference to FIGS. 13 to 18. First, the public key registration request processing performed by the payment device 10 will be described with reference to FIG. 13. FIG. 13 is a flowchart illustrating an example of public key registration request processing according to the embodiment. The public key registration request processing is performed, for instance, in a case where payment is made from the payment device 10 to the receiving device 20, and the public key information Ik has not been registered yet.

As illustrated in FIG. 13, the key generation unit 12 generates a public key information Ik (step S101), and makes a request to the management device 30 for registration of the public key information Ik (step S102). The key generation unit 12 determines whether or not the public key information Ik is registered (step S103). When the public key information Ik is not registered (No in step S103), the flow returns to step S101, and the key generation unit 12 generates another public key information Ik. When the public key information Ik is registered (Yes in step S103), the key generation unit 12 completes the processing.

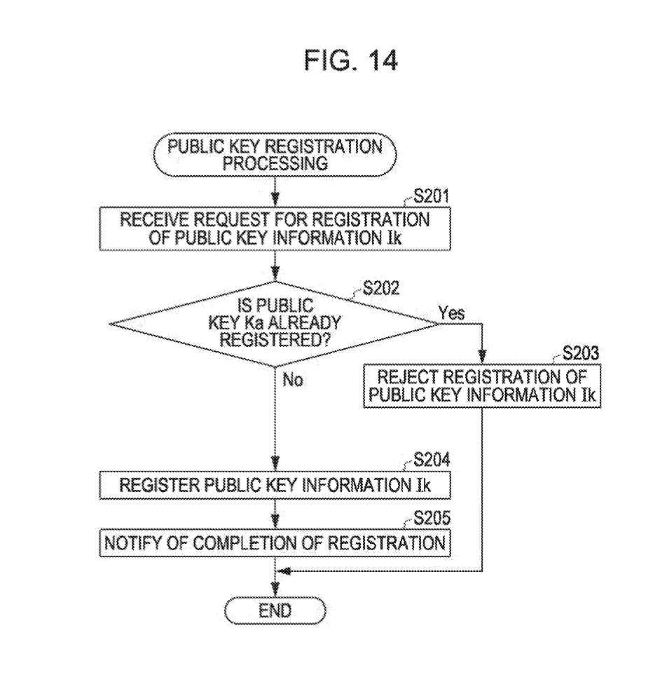

Next, the public key registration processing performed by the management device 30 will be described with reference to FIG. 14. FIG. 14 is a flowchart illustrating an example of public key registration processing according to the embodiment. The public key registration processing is performed, for instance when the management device 30 receives a request for registration of the public key information Ik from the payment device 10.

As illustrated in FIG. 14, upon receiving a request for registration of the public key information Ik (step S201), the key Tx registration unit 32 determines whether or not the public key Ka included in the public key information Ik is already registered in the distributed database (step S202). When the public key Ka is already registered in the distributed database (Yes in step S202), the key Tx registration unit 32 rejects registration of the public key information Ik for the payment device 10 (step S203), and completes the processing.

When the public key Ka is not registered in the distributed database (No in step S202), the key Tx registration unit 32 registers the public key information Ik in the distributed database (step S204), and notifies the payment device 10 of a completion of registration of the public key information Ik (step S205). It is to be noted in a case where the public key information Ik is registered in the distributed database by broadcasting the public key information Ik to the P2P network N, the key Tx registration unit 32 may skip the notification of completion of registration in step S205.

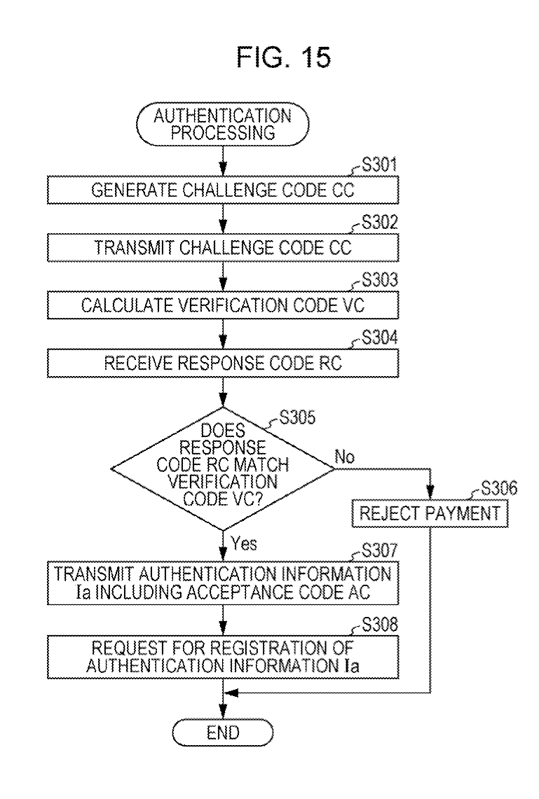

The authentication processing performed by the receiving device 20 will be described with reference to FIG. 15. FIG. 15 is a flowchart illustrating an example of authentication processing according to the embodiment. The authentication processing is performed when payment is made from the payment device 10 to the receiving device 20.

As illustrated in FIG. 15, the challenge generation unit 22 generates a challenge code CC by using the obtained public key information Ik (step S301), and transmits the challenge code CC to the payment device 10 (step S302).

The acceptance determination unit 23 calculates a verification code VC (step S303), and upon receiving a response code RC from the payment device 10 (step S304), the acceptance determination unit 23 determines whether or not the received response code RC matches the verification code VC (step S305). When the acceptance determination unit 23 determines that the response code RC does not match the verification code VC (No in step S305), the acceptance generation unit 24 rejects payment to the payment device 10 (step S306), and completes the processing.

When the acceptance determination unit 23 determines that the response code RC matches the verification code VC (Yes in step S305), the acceptance generation unit 24 transmits the authentication information Ia including the generated acceptance code AC to the payment device 10 (step S307), and makes a request to the management device 30 for registration of the authentication information Ia (step S308). It is to be noted in a case where the acceptance generation unit 24 makes a request for registration of the authentication information Ia by broadcasting the authentication information Ia to the P2P network N, the acceptance generation unit 24 may skip the transmission of the authentication information Ia in step S307. Further, the processing in step S303 and step S304 may be replaced, and may be performed concurrently.

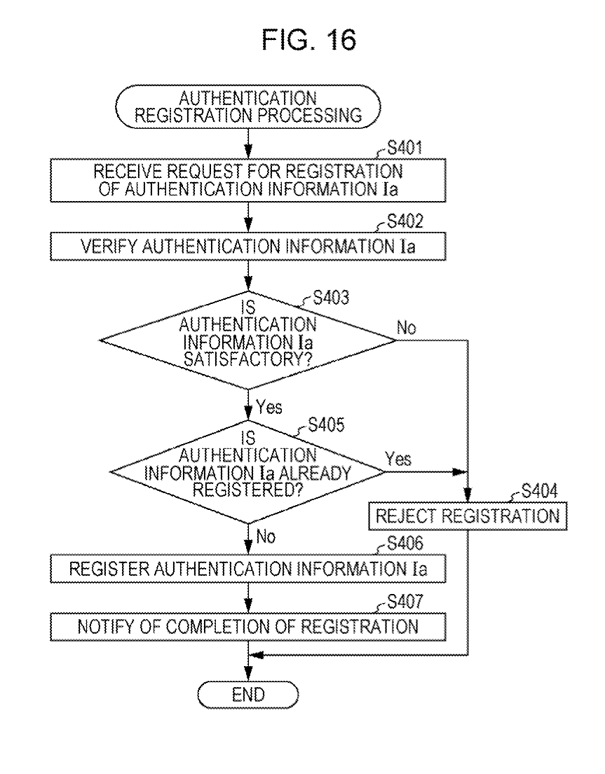

The authentication registration processing performed by the management device 30 will be described with reference to FIG. 16. FIG. 16 is a flowchart illustrating an example of authentication registration processing according to the embodiment. The authentication registration processing is performed, for instance, when the management device 30 receives a request for registration of the authentication information Ia from the receiving device 20.

As illustrated in FIG. 16, upon receiving a request for registration of authentication information Ia from the receiving device 20 (step S401), the authentication Tx registration unit 33 verifies the authentication information Ia (step S402). The authentication Tx registration unit 33 verifies the authentication information Ia, for instance, by determining whether or not the authentication information Ia includes all of the challenge code CC, the response codes RC, and the acceptance codes AC.

The authentication Tx registration unit 33 determines whether or not the authentication information Ia is satisfactory as a result of the verification of the authentication information Ia (step S403). When the authentication information Ia is not satisfactory (No in step S403), the authentication Tx registration unit 33 rejects registration of the authentication information Ia (step S404), and completes the processing.

When the authentication information Ia is satisfactory (Yes in step S403), the authentication Tx registration unit 33 determines whether or not the authentication information Ia is already registered in the distributed database (step S405). When the authentication information Ia is already registered in the distributed database (Yes in step S405), the authentication Tx registration unit 33 rejects registration of the authentication information Ia for the payment device 10 in step S404, and completes the processing.

When the authentication information Ia is not registered in the distributed database (No in step S405), the authentication Tx registration unit 33 registers the authentication information Ia in the distributed database (step S406), and notifies the payment device 10 and the receiving device 20 of a completion of registration of the authentication information Ia (step S407). It is to be noted in a case where the authentication information Ia is registered in the distributed database by broadcasting the authentication information Ia to the P2P network N, the authentication Tx registration unit 33 may skip the notification of completion of registration in step S407.

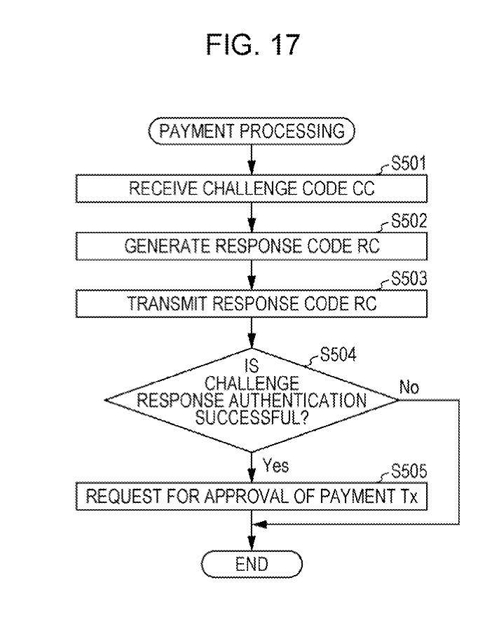

The payment processing performed by the payment device 10 will be described with reference to FIG. 17. FIG. 17 is a flowchart illustrating an example of payment processing according to the embodiment. The payment processing is performed when payment is made from the payment device 10 to the receiving device 20 and the challenge response authentication is performed between the payment device 10 and the receiving device 20.

As illustrated in FIG. 17, upon receiving a challenge code CC from the receiving device 20 (step S501), the response generation unit 13 generates a response code RC (step S502), and transmits the response code RC to the receiving device 20 (step S503). The payment processing unit 14 determines whether or not the challenge response authentication between the payment device 10 and the receiving device 20 is successful (step S504). The payment processing unit 14 determines that the challenge response authentication is successful, for instance, when an acceptance code AC is received from the receiving device 20 and a notification of completion of registration of the authentication information Ia is received from the management device 30.

When at least one of an acceptance code AC and a notification of completion of registration of the authentication information Ia is not received, the payment processing unit 14 determines that the challenge response authentication is unsuccessful (No step S504), and completes the processing without making payment.

When both an acceptance code AC and a notification of completion of registration of the authentication information Ia are received, the payment processing unit 14 determines that the challenge response authentication is successful (Yes step S504), and makes a request to the management device 30 for approval of the payment Tx to the receiving device 20 (step S505).

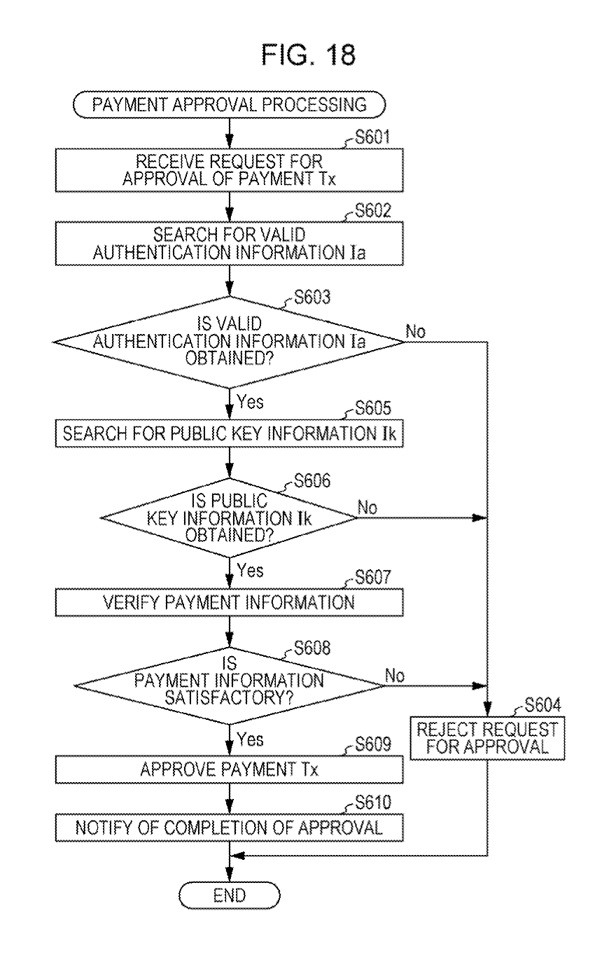

The payment approval processing performed by the management device 30 will be described with reference to FIG. 18. FIG. 18 is a flowchart illustrating an example of payment approval processing according to the embodiment. The payment approval processing is performed when the management device 30 receives a request for approval of a payment Tx from the payment device 10.

As illustrated in FIG. 18, when the payment Tx registration unit 34 receives a request for approval of a payment Tx (step S601), the authentication determination unit 36 searches the distributed database for valid authentication information Ia (step S602), and determines whether or not valid authentication information Ia is obtained (step S603). The valid authentication information Ia is information that indicates successful challenge response authentication between the payment device 10 and the receiving device 20. When valid authentication information Ia is not obtained, in other words, when the challenge response authentication is unsuccessful (No in step S603), the authentication determination unit 36 rejects approval for payment Tx (step S604), and completes the processing.

When the authentication determination unit 36 obtains valid authentication information Ia, in other words, when the challenge response authentication is successful (Yes in step S603), the public key determination unit 35 searches the distributed database for public key information Ik (step S605), and determines whether or not the public key information Ik is obtained (step S606). When the public key information Ik is not obtained (No in step S606), the flow proceeds to step S604, and the public key determination unit 35 rejects approval for the payment Tx, and completes the processing.

When the public key determination unit 35 obtains the public key information Ik (Yes in step S606), the approval determination unit 37 verifies the payment information included in the payment Tx (step S607), and determines whether or not the payment information is satisfactory (step S608). When the payment information is not satisfactory (No in step S608), the flow proceeds to step S604, and the approval determination unit 37 rejects approval for the payment Tx, and completes the processing.

When the payment information is satisfactory (Yes in step S608), the storage processing unit 38 stores the payment Tx in the distributed database, thereby approving the payment Tx (step S609), and notifies the payment device 10 and the receiving device 20 of completion of the approval (step S610).

It is to be noted when the payment Tx is registered in the distributed database by broadcasting the payment Tx to the P2P network N, the storage processing unit 38 may skip the notification of completion of approval in step S610.

The management device 30 may perform the payment authentication processing by replacing steps S602, S603 with steps S605, S606. Alternatively, the management device 30 may perform steps S602, S603 and steps S605, S606 concurrently.

### Aspect of Effects

As described above, the management device 30 according to this embodiment determines whether or not public key information Ik on public key Ka used for a payment transaction Tx made between the payment device 10 and the receiving device 20 is stored in the distributed database. The management device 30 determines whether or not the challenge response authentication using the public key Ka is successful between the payment device 10 which has made the payment transaction Tx and the receiving device 20. When the public key information Ik is stored in the distributed database and the challenge response authentication is successful, the management device 30 stores information on the payment transaction Tx using the public key Ka in the distributed database. Consequently, unauthorized payment transaction Tx using duplicated secret key KPa and public key Ka is unlikely to be registered in the distributed database, and the conduct of unauthorized payment transaction Tx may be prohibited.

Also, the management device 30 according to this embodiment stores information on the payment transaction Tx using public key information Ik, authentication information Ia on challenge response authentication, and public key Ka in the distributed database as single piece of transaction information. Thus, for instance, a node such as the payment device 10 included in the transaction system 1 may refer to the public key information Ik and the authentication information Ia by referring to the payment transaction Tx. This allows the node to easily refer to the public key information Ik and the authentication information Ia, and the validity of the payment transaction Tx may be easily verified.

Also, the management device 30 according to this embodiment determines whether or not public key Ka is stored in the distributed database, and when public key Ka is not stored in the distributed database, stores public key information Ik in the distributed database. Thus, the management device 30 may avoid duplication of public key information Ik including the public key Ka, and the conduct of unauthorized payment transaction Tx using a duplicated key pair may be prohibited.

Also, the management device 30 according to this embodiment stores public key information Ik including public key Ka and the first information dxKa generated using the public key Ka in the distributed database. Thus, the payment device 10 and the receiving device 20 may perform challenge response authentication using the first information dxKa, and the conduct of unauthorized payment transaction Tx using a duplicated key pair may be prohibited.

Also, when challenge response authentication is successful, the management device 30 according to this embodiment stores the authentication information Ia including information that indicates successful authentication in the distributed database. Thus, when challenge response authentication is successful, the management device 30 may store the payment transaction Tx in the distributed database. Therefore, the management device 30 may prohibit the conduct of unauthorized payment transaction Tx.

[Distribution and Integration]

Also, the components of illustrated devices do not have to be physically formed as illustrated. Specifically, a specific configuration of distribution and integration of the devices is not limited to what is illustrated, and all or part of the devices may be functionally or physically configured to be distributed and integrated in any unit according to various loads and use conditions. For instance, the public key determination unit 35 or the authentication determination unit 36 may be coupled via a network as an external device of the management device 30. Alternatively, the public key determination unit 35 or the authentication determination unit 36 may be respectively included by separate devices, and the function of the above-described management device 30 may be implemented by a network connection and cooperative work. In addition, in the embodiment, a case has been illustrated in which the payment device 10, the receiving device 20, and the management device 30 are implemented by installing the wallet into a personal computer. However, those devices may be implemented without installing the wallet into a personal computer or may be implemented as cloud computing that provides payment transaction Tx of crypto currency by outsourcing.

[Transaction Management Program]

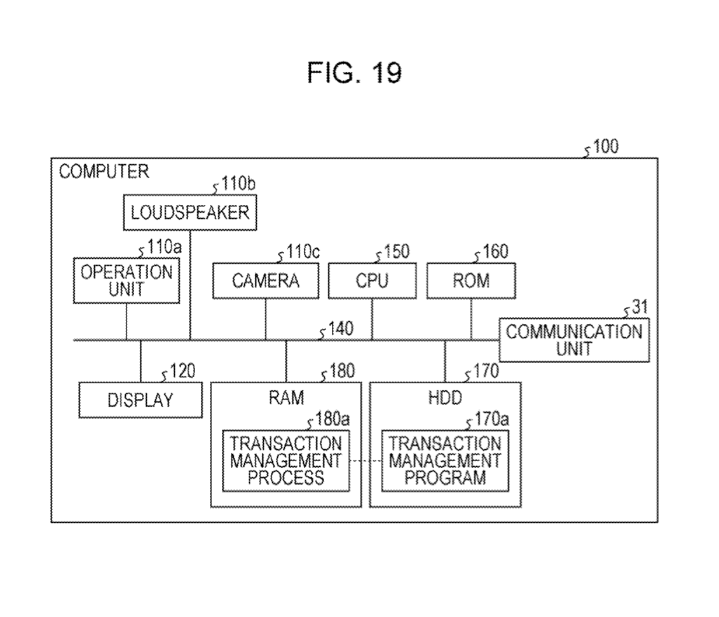

The various types of processing described in the embodiment are each achieved by executing a program prepared in advance by a computer such as a personal computer or a workstation. Thus, hereinafter an example of a computer that executes a control program having the same function as in the embodiment will be described with reference to FIG. 19. It is to be noted a case will be described herein as an example in which the processing performed by the management device 30 is achieved by executing a transaction management program by a computer. However, the same goes with the processing performed by the payment device 10 and the receiving device 20.

FIG. 19 is a diagram illustrating an example of a hardware configuration of a computer that executes a transaction management program according to the embodiment. As illustrated in FIG. 19, a computer 100 includes an operation unit 110a, a loudspeaker 110b, a camera 110c, a display 120, and a communication unit 31. In addition, the computer 100 includes a CPU 150, a ROM 160, a HDD 170, and a RAM 180. These units 110 to 180 are coupled via a bus 140.

As illustrated in FIG. 19, the HDD 170 stores a transaction management program 170a that has the same function as the function of the key Tx registration unit 32, the authentication Tx registration unit 33, and the payment Tx registration unit 34 presented in the embodiment. The transaction management program 170a may be integrated or separated in the same manner as in the components of the key Tx registration unit 32, the authentication Tx registration unit 33, and the payment Tx registration unit 34 illustrated in FIG. 11.

Under such an environment, the CPU 150 reads the transaction management program 170a from the HDD 170, and the transaction management program 170a is deployed on the RAM 180. Consequently, the transaction management program 170a serves as a transaction management process 180a as illustrated in FIG. 19. The transaction management process 180a deploys various types of data read from the HDD 170 on an area allocated to the transaction management process 180a out of the storage area of the RAM 180, and various types of processing are performed using the deployed various data. For instance, an example of processing performed by the transaction management process 180a includes the processing illustrated in FIG. 14. It is to be noted in the CPU 150, all the processing units illustrated in the embodiment do not have to be performed, and a processing unit corresponding to processing as an execution target only has to be virtually implemented.

It is to be noted the above-mentioned transaction management program 170a does not have to be initially stored in the HDD 170 and the ROM 160. For instance, the transaction management program 170a is stored in a flexible disk inserted in the computer 100, what is called “portable physical medium” such as an FD, a CD-ROM, a DVD disk, a magneto-optical disc, and an IC card. Also, the computer 100 may obtain the transaction management program 170a from these portable physical media, and may execute it. Alternatively, the transaction management program 170a may be stored in another computer or a server apparatus coupled to the computer 100 via a public line, the Internet, a LAN, or a WAN, and the computer 100 may obtain the transaction management program 170a from the computer or the apparatus, and may execute it.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method performed by at least one processor, the method comprising:
determining whether public key information on a public key used by a transaction made between nodes coupled to each other via a network is stored in a distributed database;
determining whether challenge response authentication using the public key is successful between the nodes between which the transaction is made; and
when the public key information is stored in the distributed database and the challenge response authentication is successful, storing information on the transaction using the public key in the distributed database.

2. The method of claim 1, further comprising:
storing, in the distributed database, the public key information, authentication information on the challenge response authentication, and the information on the transaction using the public key as a single piece of transaction information.

3. The method of claim 1, further comprising:
determining whether the public key is stored in the distributed database, and
when the public key is not stored in the distributed database, storing the public key information in the distributed database.

4. The method of claim 3, further comprising:
storing, in the distributed database, the public key and the public key information including first information generated using the public key.

5. The method of claim 1, further comprising:
when the challenge response authentication is successful, storing, in the distributed database, authentication information including information that indicates successful authentication.

6. The method of claim 5, further comprising:
storing, in the distributed database, the authentication information on:
first challenge transmission processing that transmits a challenge code generated using the public key and confidential information,
response receiving processing that receives a response code generated using the challenge code, and
acceptance transmission processing that transmits an acceptance code indicating successful challenge response authentication when the response code matches a code that is generated by using the first information generated using the public key and the confidential information.

7. The method of claim 6, further comprising:
storing, in the distributed database, the authentication information on second challenge transmission processing which transmits a challenge code generated using the confidential information that varies with the challenge response authentication.

8. A non-transitory, computer-readable recording medium having stored therein a program for causing a computer to execute a process comprising:
determining whether public key information on a public key used by a transaction made between nodes coupled to each other via a network is stored in a distributed database;
determining whether challenge response authentication using the public key is successful between the nodes between which the transaction is made; and
when the public key information is stored in the distributed database and the challenge response authentication is successful, storing information on the transaction using the public key in the distributed database.

9. An apparatus comprising:
a processor configured to:
determine whether public key information on a public key used by a transaction made between nodes coupled to each other via a network is stored in a distributed database,
determine whether challenge response authentication using the public key is successful between the nodes between which the transaction is made, and
when the public key information is stored in the distributed database and the challenge response authentication is successful, store information on the transaction using the public key in the distributed database; and
a memory coupled to the processor and configured to store data used for processing executed by the processor.
